(19) United States
(12) Patent Application Publication
(10) Pub. No.: US 2009/0195747 A1
(43) Pub. Date: Aug. 6, 2009

(54) Interchangeable eyeglass temples

(76) Inventor: Luisa M. Insua, Lutz, FL (US)

Correspondence Address: LANGDALE & VALLOTTON, LLP, 1007 N. PATTERSON STREET, VALDOSTA, GA, 31601, US

(21) Appl. No.: 12/012,591

(22) Filed: Feb. 4, 2008

(51) Int. Cl. G02C 5/14; G02C 5/22

(52) U.S. Cl. 351/116; 351/140

(57) ABSTRACT

Temple holders each having recesses formed in the holders are hinged to the extreme ends of an eyeglass front. Temple ends, inserted into respective holder recesses secure the temples in proper position relative to the front. Magnets within the recesses and the temple ends having polar orientations that establish magnetic attraction with each other join the temples to the front through the temple holders. The temple holders reinforce the coupling of the temples with the front during ordinary wear to prevent an undesirable separation of a temple from its front. Selective separation of the temples from the front, however, enables the wearer to change temple styles, as appropriate.

### CROSS-REFERENCES TO RELATED APPLICATIONS

None

### STATEMENT REGARDING FEDERALLY SPONSORED RESEARCH OR DEVELOPMENT

None

### JOINT RESEARCH AGREEMENT PARTNER

None

### REFERENCE TO “SEQUENCE LISTING”

None

### BACKGROUND OF THE INVENTION

### FIELD OF THE INVENTION

This invention relates to temples for eyeglasses and, more particularly, to a magnetic coupling that enables eyeglass temples to be swiftly and easily changed while nevertheless remaining securely in place during eyeglass use, and the like.

Eyeglasses usually have a front that holds the lenses before the eyes of the wearer. A pair of temples frequently are hinged to the opposite extremities of the front. These temples extend from the front to behind the wearer's ears in order to keep the front in its proper position on the wearer. Ordinarily one end of each of these temples is hinged to a respective end of the front to enable the temples to be folded when the eyeglasses are not in use and to be opened up when the eyeglasses are to be worn.

Small screws often are used not only to join the temples to the front, but also to serve as pins for the temple hinges. One proposal would substitute magnets for these hinge screws. The proposal to substitute magnets for the hinge screws, however, appears to be unsatisfactory because nonuniformities in the magnetic fields may require some adjustment to align properly each of the temples with the front. Further in this regard, the small size of the magnets limit the magnetic force available to join each of the temples to the frame. This limited magnetic force nevertheless is required to sustain all of the stresses applied to the eyeglass hinges during use. This could create embarrassing or aggravating situations for the wearer in which stresses encountered in ordinary eyeglass use exceed the limited strengths of the magnetic fields and cause one or both of the temples to separate from the front and thus fall apart while being worn.

There is a need, moreover, to permit an eyeglass wearer to switch temples from time to time in order to change the styling for the eyeglasses from, for example, daytime wear with business or casual dress to a style more suitable for evening wear.

Consequently, there is a need for a better structure to selectively join temples to eyeglass fronts that overcomes these apparent inadequacies of earlier proposals.

### BRIEF SUMMARY OF THE INVENTION

These and other unsatisfactory characteristics of the prior art are avoided to a large extent through the practice of the invention. For example, in accordance with an illustrative embodiment of the invention, stub-like receptacles, or temple holders, having recesses are hinged to the extreme ends of the front. Temple ends are inserted into the temple holder recesses which align magnets at the temple ends with associated magnets in these recesses. The temple holders thus magnetically coupled to the temples engage the temple ends enabling the temple holders to bear most of the stresses imposed on the front and temples combination through ordinary wear. In this manner the problems of temple and front alignment and undesirable temple and front separation during use are generally overcome.

Assembled in the foregoing manner, the hinged temple holders permit the temples to be folded during non-use and opened for use. Alternatively, the temples can be removed and the holders without the temples folded against the front for storage.

These and other advantages of the invention will become apparent through the following detailed description of a preferred embodiment of the invention when taken with the figures of the drawing. The scope of the invention, however, is limited only through the claims appended hereto.

### BRIEF DESCRIPTION OF THE DRAWING

FIG. 1 is an exploded perspective side view of a portion of an eyeglass that illustrates an embodiment of the invention;

FIG. 2 is a rear view of an entire eyeglass front, only part of which is shown in FIG. 1;

FIG. 3 is a perspective side view assembly drawing of the portion of an eyeglass shown in FIG. 1; and

FIG. 4 is a detailed drawing, in side elevation and in partial section of the assembled hinged temple holder and a portion of the associated temple shown in FIG. 3.

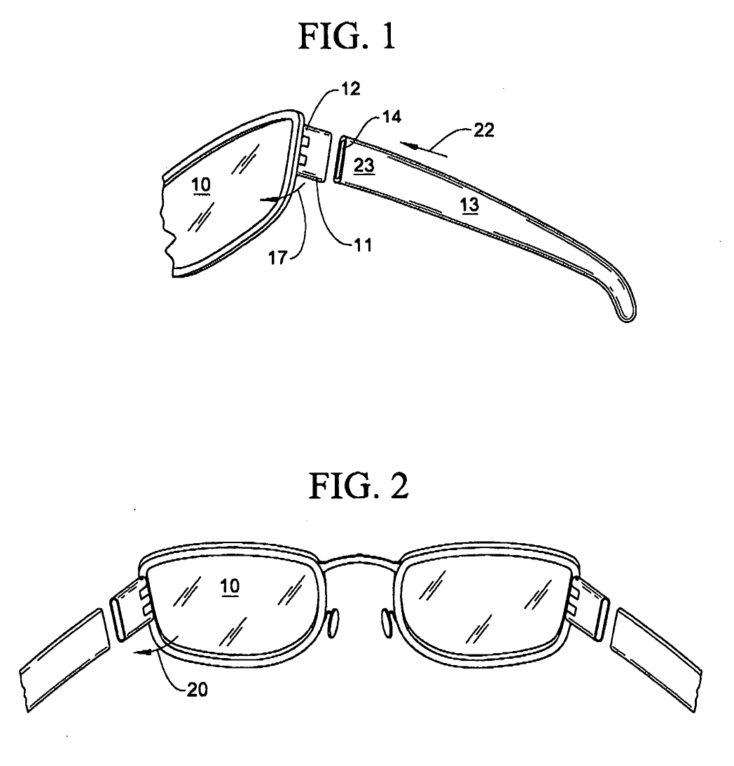

As best shown in FIG. 1 an eyeglass front 10 has a temple holder 11 that is joined to the front 10 through a hinge 12. A temple 13 has a temple magnet 14 secured to temple end 23 by embedding the magnet 14 in the temple material, or adhesively joining the magnet 14 to the temple 13 through an appropriate epoxy glue or by other suitable means. The temple end 23 and the magnet 14, moreover, are received snugly within a recess 15 (FIG. 4) formed in the temple holder 11.

Illustrated in FIG. 4 is a screw 16 that not only joins the holder 11 to the front 10 (FIG. 1), but also serves as a hinge pin for the hinge 12 enabling the holder 11 to fold in the direction of arrow 17 essentially flat against the front 10 or turn in the direction of arrow 20 (FIG. 2) to a position that is approximately perpendicular to the front 10.

Turning once more to the temple holder 11 that is shown in FIG. 4, the temple holder 11 has the matching temple end 23 received in the rectangular recess 15. A holder magnet 21 also is appropriately secured in the end of the recess 15. Note that orientation of the north/south polarity (indicated by the letters N and S in FIG. 4) of the holder magnet 21 is opposite to the polarity of the magnet 14 in the temple 13 to permit the two magnets 14 and 21 to attract each other and hold the temple 13 in the recess 15. Magnets suitable for the purpose of this invention, moreover, can be of any appropriate magnetic strength provided by magnets or magnetizable materials such as alnico, iron and the like.

In operation, and as shown in FIG. 1, the temple 13 is moved in the direction of arrow 22 to insert the magnet 14 and the associated end 23 of the temple 13 into the mating recess 15 (FIG. 4) within the temple holder 11. Further in this respect, the shapes of the recess 15 and the temple end 23 align the magnets 14 and 21 for magnetic coupling. The relative position of the north and south magnetic polarities of the temple magnet 14 and the holder magnet 21 is such that there is a strong mutual attraction between these two magnets that keeps the end 23 of the temple 13 securely mounted within the recess 15. The end 23 of the temple 13, so seated within the recess 15, relies not only on the mutually attracting magnetic forces developed by the magnets 14 and 21 for stable retention on the front 10, but also on the reinforcing influence of the temple holder 11 on the temple end 23. Thus, those forces generated during eyeglass use that otherwise might overcome the mutual attraction of the magnets 14 and 21 and separate the temple 13 from the temple holder 11 are attenuated and absorbed by the temple holder 11. Further in this respect, because of the alignment between the magnets 14 and 21 provided by the fit between the temple end 23 and the recess 15, frequent adjustment to overcome any undesirable misalignments between the temple 13 and the front 10 as a consequence of irregularities in the magnetic field distributions are avoided.

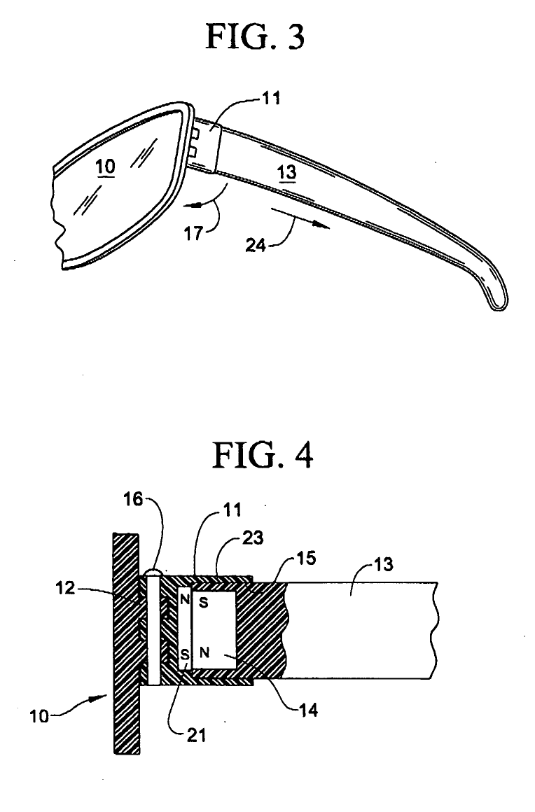

To change the temple 13 it is only necessary, as best shown in FIG. 3, to draw the temple 13 manually out of its seating in the recess 15 (not shown in FIG. 3) within the temple holder 11 in the direction of arrow 24 merely by overcoming the magnetic attraction of the magnets 14 and 21 and the friction forces between the sides of the recess 15 and the temple end 23.

When folding the temple 13 against the front 10 to store the eyeglasses, the user need only press the temple 13 in the direction of the arrow 17 (FIG. 1). To open the temple 13, press the temple 13 (FIG. 2) in the direction of the arrow 20 to place the front 10 and the temple 13 in a condition for wear, lens cleaning and the like.

As a result, the foregoing preferred embodiment of the invention avoids many of the unsatisfactory features that have characterized prior art front and temple combinations. Naturally, a number of structural variations are possible within the scope of this invention. For example, the location of the magnets can be changed so that they are mounted in the sides of the receptacles and the sides of the temple ends. A further instance would reverse the position of the recess 15 to place that recess within the temple end 23 and enable a portion of the temple holder 11 to fit within the recess in the temple holder end 23.

What is claimed is:

1. Eyeglasses having a front comprising a temple holder having a recess formed therein, a magnet within said recess and a hinge joining said temple holder to the front.

2. Eyeglasses according to claim 1 further comprising a temple having an end for selective mounting in said temple holder recess, a magnet at said temple end having a magnetic polar orientation to establish mutual magnetic attraction with said magnet within said recess.

3. Eyeglasses according to claim 2 wherein said temple end magnet is secured in said temple end.

4. Eyeglasses according to claim 3 wherein said magnets within said recess and said temple end are embedded in said temple holder and said temple end respectively.

5. Eyeglasses according to claim 3 wherein an epoxy resin glue adheres said magnet within said recess to said temple holder and said temple magnet to said temple end.

6. An eyeglass temple comprising an end formed on the temple, said end having a recess formed therein, a magnet secured to the eyeglass temple within said temple recess.

7. An eyeglass temple comprising an end formed on the temple, and a magnet secured to the eyeglass temple.
